(19) United States
(12) Patent Application Publication
(10) Pub. No.: US 2023/0177381 A1
(43) Pub. Date: Jun. 8, 2023

(54) Accelerating the Training of Machine Learning (ML) Models via Data Instance Compression

(71) Applicant: VMware, Inc., Palo Allo, CA (US)

(72) Inventors: Yaniv Ben-Itzhak, Herzliya (IL); Shay Vargaftik, Herzliya (IL); Boris Shustin, Tel Aviv (IL)

(21) Appl. No.: 17/535,483

(22) Filed: Nov. 24, 2021

(51) Int. Cl. G06N 20/00

(52) U.S. Cl. CPC G06N 20/00

(57) ABSTRACT

Techniques for accelerating the training of machine learning (ML) models in the presence of network bandwidth constraints via data instance compression. For example, consider a scenario in which (1) a first computer system is configured to train a ML model on a training dataset that is stored on a second computer system remote from the first computer system, and (2) one or more network bandwidth constraints place a cap on the amount of data that may be transmitted between the two computer systems per training iteration. In this and other similar scenarios, the techniques of the present disclosure enable the second computer system to send, according to one of several schemes, a batch of compressed data instances to the first computer system at each training iteration, such that the data size of the batch is less than or equal to the data cap.

### BACKGROUND

Unless otherwise indicated, the subject matter described in this section is not prior art to the claims of the present application and is not admitted as being prior art by inclusion in this section.

Deep neural networks (DNNs), which are machine learning (ML) models composed of multiple layers of interconnected nodes, are widely used to solve tasks in various fields such as computer vision, natural language processing, telecommunications, bioinformatics, and so on. A DNN is typically trained via a stochastic gradient descent (SGD)-based optimization procedure that involves (1) randomly sampling a batch (sometimes referred to as a “minibatch”) of labeled data instances from a training dataset, (2) forward propagating the batch through the DNN to generate a set of predictions, (3) computing a difference (i.e., “loss”) between the predictions and the batch’s labels, (4) performing backpropagation with respect to the loss to compute a gradient, (5) updating the DNN’s parameters in accordance with the gradient, and (6) iterating steps (1)-(5) until the DNN converges (i.e., reaches a state where the loss falls below a desired threshold). Once trained in this manner, the DNN can be applied during an inference phase to generate predictions for unlabeled data instances.

Generally speaking, the use of larger batch sizes for SGD-based training leads to faster DNN convergence. Unfortunately, in cases where the training dataset is stored remotely from the computer system(s) executing the training procedure, it not uncommon for network bandwidth constraints to limit the amount of data (and thus the number of data instances (i.e., batch size)) that can be transmitted to those computer system(s) at each training iteration, resulting in significantly longer training times.

### BRIEF DESCRIPTION OF THE DRAWINGS

FIG. 1 depicts an example environment in which embodiments of the present disclosure may be implemented.

FIG. 2 depicts an example DNN.

FIG. 3 depicts a flowchart for training a DNN via SGD according to certain embodiments.

FIG. 4 depicts an example training dataset with sampling probabilities.

FIG. 5 depicts a flowchart for implementing a batch-level compression scheme according to certain embodiments.

FIG. 6 depicts a flowchart for implementing an instance-level compression scheme according to certain embodiments.

FIG. 7 depicts a flowchart for implementing an importance sampling-based compression scheme according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for accelerating the training of DNNs (and other similar ML models) in the presence of network bandwidth constraints via data instance compression. For example, consider a scenario in which (1) a first computer system is configured to train a DNN using SGD on a training dataset that is stored on a second computer system remote from the first computer system, and (2) one or more network bandwidth constraints place a cap on the amount of data that may be transmitted between the two computer systems per training iteration. In this scenario, the techniques of the present disclosure enable the second computer system to send, according to one of several schemes described below, a batch of compressed data instances to the first computer system at each training iteration, such that the aggregate data size of the batch is less than or equal to the data cap. As used herein, a “compressed data instance” is a data instance that has been reduced in size using a lossy compression algorithm that discards some amount of less important information in the data instance’s content (and thus introduces a degree of noise). Further, the phrase “batch size” refers to the number of data instances in a batch, while “batch data size” or “data size of a batch” refers to the total amount of data (e.g., in bytes or any other unit of digital information) in a batch. By compressing data instances in each batch as described above, the second computer system can provide the first computer system with a larger batch size per iteration than would otherwise be possible given the network bandwidth constraints, resulting in faster DNN convergence.

### 2. Example Environment and High-Level Solution Design

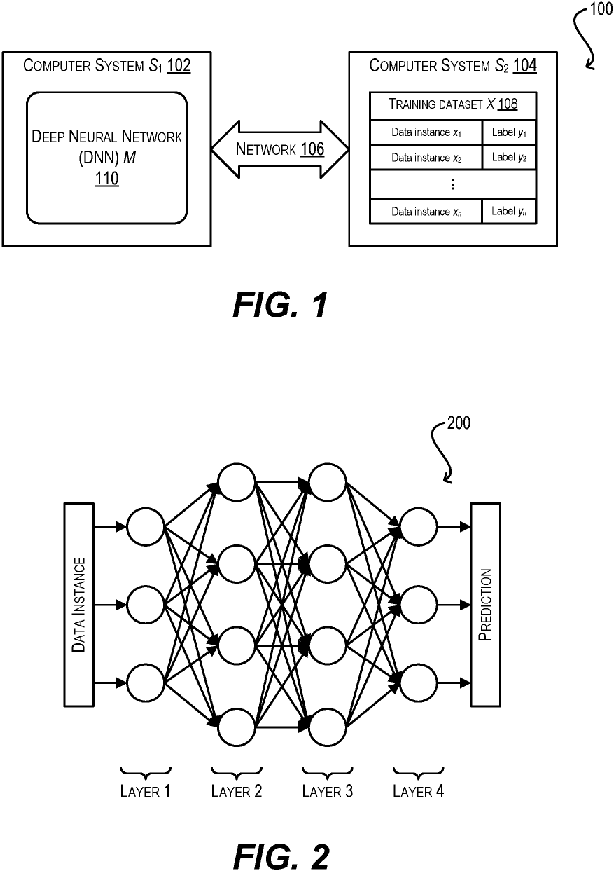

FIG. 1 depicts an example environment 100 in which embodiments of the present disclosure may be implemented. As shown, environment 100 includes two computer systems S₁ and S₂ (reference numerals 102 and 104) that are communicatively coupled via a network 106. Computer system S₂ holds a training dataset X (reference numeral 108) comprising n data instances {x₁, ... , xₙ}, each associated with a label yⱼ indicating the correct prediction/output for that data instance. Computer system S₁ holds a DNN M (reference numeral 110) and is configured to train M on training dataset X.

DNN M is type of ML model that comprises a collection of nodes, also known as neurons, that are organized into layers and interconnected via directed edges. For instance, FIG. 2 depicts an example representation 200 of DNN M that includes a total of fourteen nodes and four layers 1-4. The nodes and edges are associated with parameters (e.g., weights and biases, not shown) that control how a data instance, when provided as input via the first layer, is forward propagated through the DNN to generate a prediction, which is output by the last layer. These parameters are the aspects of the DNN that are adjusted via training in order to optimize the DNN’s accuracy (i.e., ability to generate correct predictions).

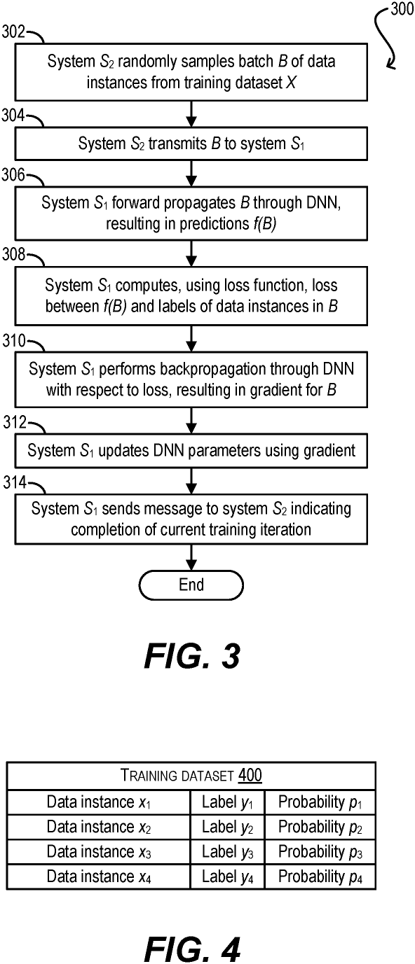

FIG. 3 depicts a flowchart 300 that may be executed by computer systems S₁ and S₂ for training DNN M on training dataset X using a conventional SGD-based procedure. SGD-based training proceeds over a series of iterations and flowchart 300 depicts the steps performed in a single iteration. Starting with steps 302 and 304, computer system S₂ randomly samples a batch B of data instances from training dataset X and transmits B to computer system S₁. At step 306, computer system S₁ forward propagates the batch through DNN M, resulting in a set of predictions ƒ(B). Computer system S₁ further computes a loss between ƒ(B) and the labels of the data instances in B using a loss function (step 308) and performs backpropagation through DNN M with respect to the computed loss, resulting in a gradient vector (or simply “gradient”) for B (step 310). Finally, computer system S₁ updates the parameters of DNN M using the gradient (step 312), sends a message to computer system S₂ indicating completion of the current training iteration (step 314), and the flowchart ends. Steps 302-314 are thereafter repeated for further iterations until DNN M converges (i.e., achieves a desired level of accuracy) or some other termination criterion, such as a maximum number of training iterations, is reached.

As mentioned previously, in some scenarios computer systems S₁ and S₂ may be subject to one or more hard or soft network bandwidth constraints that place a data cap C on the amount of data that may be communicated between these computer systems at each training iteration. A hard network bandwidth constraint is one where data cap C cannot be exceeded due to, e.g., characteristics of the systems or the network. For example, computer system S₁ may be an edge device (e.g., a smartphone, tablet, Internet of Things (IoT) device, etc.) with unstable network reception and/or network hardware that is constrained by power limitations. A soft network bandwidth constraint is one where data cap C can be exceeded, but there are reasons/motivations to avoid doing so. For example, computer system S₂ may be part of a cloud storage service platform such as Amazon S3 that charges customers a fee for every K units of data that are retrieved from the platform, thereby motivating the owner/operator of computer system S₁ to stay within data cap C in order to minimize training costs. The presence of these hard or soft bandwidth constraints are problematic because such a data cap can significantly reduce the number of data instances (i.e., batch size) that computer system S₁ can apply per iteration in order to train DNN M, which in turn can undesirably lengthen the overall training time.

To address the foregoing and other similar issues, embodiments of the present disclosure provide several schemes that leverage lossy data instance compression to increase the size of the batches sent from computer system S₂ to computer system S₁ as part of the SGD-based training of DNN M, thereby accelerating the training procedure without violating data cap C. For example, according to a first scheme (referred to herein as the “global compression scheme”), computer system S₂ can apply a global compression level L to all data instances of all batches/iterations of the training procedure, resulting in a single (large) batch size for the entirety of the procedure. Global compression level L can be set based on data cap C, the average size of the data instances in training dataset X, the nature/purpose of DNN M, and/or other factors. In a particular embodiment, global compression level L can be set to achieve a batch size that is close or identical to a “best-practice” batch size for DNN M (i.e., the batch size that minimizes training time while avoiding overfitting of the training data), which allows for fast convergence of M at the expense of some model accuracy (due to the amount of noise introduced into every data instance).

According to a second scheme (referred to herein as the “batch-level compression scheme” and detailed in section (3) below), computer system S₂ can apply a per-batch compression level L(i) to the data instances in batch B(i) of each iteration i. This scheme results in a batch size that changes over time (i.e., across iterations) and thus is capable of achieving a better balance between training time and model accuracy than the global compression scheme, but remains relatively straightforward to implement by maintaining a consistent compression level for all of the data instances in a given batch.

In one set of embodiments, computer system S₂ can determine per-batch compression level L(i) in a deterministic manner, such as by consulting a predefined schedule that specifies the compression level (or batch size) for each batch/iteration. For example, the predefined schedule may indicate that all data instances in batches/iterations 1 to 100 should be compressed with a high compression level, all data instances in batches/iterations 101 to 200 should be compressed with a medium-high compression level, all data instances in batches/iterations 201 to 300 should be compressed with a medium-low compression level, and all data instances in batches/iterations 301 onward should be compressed with a low compression level. This type of schedule, referred to herein as a “progressive descent” schedule, uses a high compression level/large batch size during the initial iterations in order to get relatively close to the desired accuracy of DNN M quickly and then progressively decreases the compression level/batch size over subsequent iterations to more precisely home in on the desired accuracy and reach convergence.

In another set of embodiments, computer system S₂ can determine per-batch compression level L(i) in a dynamic manner, such as by examining a current state of DNN of M at iteration i. For example, in a particular embodiment computer system S₂ can retrieve the loss value computed by computer system S₁ with respect to immediately prior batch B(i - 1) and determine per-batch compression level L(i) as a function of that loss value. In this embodiment, the function may be designed to output higher compression levels for higher loss values and lower compression levels for lower loss values, which achieves a similar strategy as the progressive descent-type schedule discussed above (i.e., quickly approach a neighborhood around the desired accuracy of DNN M via large batch sizes and then converge on the desired accuracy using smaller batch sizes).

According to a third scheme (referred to herein as the “instance-level compression scheme” and detailed in section (4) below), computer system S₂ can apply a per-instance compression level L(i,j) to each data instance _{Xj} in batch B(i) of each iteration i based on a compression probability distribution P(i), where P(i) defines a distribution of probabilities for a set of predetermined compression levels. For example, assume compression probability distribution P(i) is defined as follows for compression levels high, medium, and low respectively: [0.3, 0.4, 0.3]. In this case, for each data instance xⱼ in batch B(i), there is a 30% chance that xⱼ will be compressed using the high compression level, a 40% chance that xⱼ will be compressed using the medium compression level, and a 30% chance that xⱼ will be compressed using the low compression level. This scheme results in a batch size that changes over time, as well as differing compression levels for the individual data instances in each batch according to compression probability distribution P(i) . Like per-batch compression level L(i) in the batch-level compression scheme, computer system S₂ can determine compression probability distribution P(i) deterministically (e.g., based on a predefined schedule) or dynamically (e.g., based on the current state of DNN M).

And according to a fourth scheme (referred to herein as the “importance sampling-based compression scheme” and detailed in section (5) below), computer system S₂ can apply a per-instance compression level L(i,j) to each data instance xⱼ in batch B(i) of each iteration i in accordance with a sampling probability assigned to xⱼ via importance sampling. As known in the art, importance sampling is an enhancement to conventional SGD-based training that involves assigning a sampling probability to each data instance in a training dataset. This sampling probability indicates the importance, or degree of contribution, of the data instance to the training procedure’s progress towards convergence. For example, FIG. 4 depicts an example training dataset 400 that includes four data instances (x₁, x₂, x₃, x₄} with corresponding labels {y_{1,} y_{2,} y_{3,} y₄} and assigned sampling probabilities {p₁, p₂, p₃, p₄}. With these sampling probabilities in place, data instances can be sampled from the training dataset at each training iteration based on their respective probabilities, rather than randomly as described at step 302 of flowchart 300.

By integrating importance sampling and selecting the compression level for each data instance in each batch based on that data instance’s assigned sampling probability, the importance sampling-based compression scheme can advantageously (1) increase the likelihood that more important data instance instances will be sampled over less important data instances and (2) compress more important data instances with a lower compression level, thereby resulting in less noise for those important data instances, while compressing less important data instances with a higher compression level, thereby ensuring that the overall data size for the batch remains below data cap C. For example, data instances with a sampling probability of 0.3 or less may be compressed using a high compression level while data instances with a sampling probability of 0.7 or more may be compressed using a low compression level. This, in turn, can further accelerate the training procedure and lead to greater model accuracy.

It should be noted that with the approach above, the batch size for a given batch/iteration will depend on the particular data instances that are sampled for that batch/iteration and their respective sampling probabilities. For example, if computer system S₂ happens to sample only important data instances for inclusion in batch B (i), the compression levels of those data instances will be low and thus the batch size for B(i) will be low. Conversely, if computer system S₂ happens to sample a significant number of less important data instances for inclusion in a subsequent batch B(i + 1), the compression levels of those data instances will be higher and thus the batch size for B(i + 1) will be higher.

In alternative embodiments, computer system S₂ can determine, either deterministically or dynamically, a target batch size z(i) for each iteration i. Computer system S₂ can then sample, using importance sampling, exactly z(i) data instances from training dataset X for batch B(i) of iteration i and determine, in a relative manner, compression levels for these z(i) data instances based on their respective sampling probabilities that allow the total data size of batch B (i) to meet, but not exceed, data cap C. For example, if z(i) = 2 and computer system S₂ samples two data instances x₁ and x₂ that have the same sampling probability 0.5, computer system S₂ can determine a single compression level for both x₁ and x₂ that ensures the total compressed size of x₁ + x₂ will be less than or equal to C. On the other hand, if data instance x₁ has a sampling probability of 0.4 and data instance x₂ has a sampling probability of 0.6, computer system S₂ can determine a slightly higher compression level for x₁ (because it is slightly less important than x₂) and a slightly lower compression level for x₂ (because it is slightly more important than x₁) that collectively ensure the total compressed size of x₁ + x₂ will be less than or equal to C.

It should be appreciated FIGS. 1-4 and the foregoing description are illustrative and not intended to limit embodiments of the present disclosure. For example, while the foregoing description focuses on accelerating the training of DNNs via data instance compression, the techniques of the present disclosure may also be used to accelerate the training of other types of ML models that are trained using batches of data instances and achieve faster convergence through the use of larger batch sizes.

Further, the techniques of the present disclosure are not limited to a specific type of compression algorithm, and instead may employ any type of compression algorithm known in the art (or developed in the future) for compressing data instances according to the various schemes described herein. In certain embodiments, the compression algorithm employed may be selected based on the characteristics of the data instances in training dataset X. For example, if the data instances are images, a compression algorithm that is known to be effective for image compression (such as discrete cosine transform (DCT) or discrete wavelet transform (DWT)) can be selected.

Yet further, although computer systems S₁ and S₂ are shown in FIG. 1 as singular systems for ease of illustration and explanation, each of these entities may implemented using multiple computer systems for increased performance, redundancy, and/or other reasons. One of ordinary skill in the art will recognize other variations, modifications, and alternatives.

### 3. Batch-Level Compression

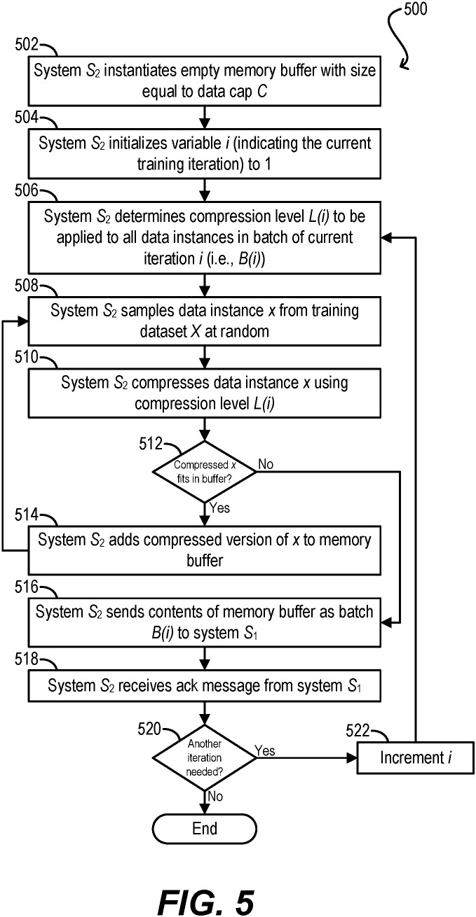

FIG. 5 depicts a flowchart 500 of the steps that may be performed by computer systems S₁ and S₂ of FIG. 1 for implementing the batch-level compression scheme as part of training DNN M on training dataset X according to certain embodiments. Flowchart 500 assumes that these computer systems are subject one or more network bandwidth constraints that place a data cap C on the total amount of data that may be communicated from computer system S₂ to computer system S₁ during each iteration of the training procedure.

Starting with steps 502 and 504, computer system S₂ can instantiate an empty memory buffer having a size equal to data cap C and can initialize a variable i indicating the current training iteration to 1.

At step 506, computer system S₂ can determine a compression level L (i) to be applied to all data instances in the batch of current iteration i (i.e., batch B(i)). As mentioned previously, computer system S₂ can perform this determination in a static/deterministic manner (e.g., based on a predefined schedule) or in a dynamic manner (e.g., based on a current state of DNN M).

At step 508, computer system S₂ can sample a data instance x from training dataset X at random. Computer system S₂ can further compress data instance x using compression level L(i) (step 510) and check whether the compressed version of x fits into the memory buffer (step 512).

If the answer at step 512 is yes, computer system S₂ can add the compressed version of data instance x to the memory buffer and return to step 508 in order to sample a next data instance (step 514). However, if the answer at step 514 is no, computer system S₂ can conclude that the memory buffer is now full (or in other words, the total data size of batch B(i) for current training iteration i has reached data cap C) and can send the contents of the memory buffer as the batch for iteration i to computer system S₁, thereby enabling S₁ to train DNN M on this batch (step 516). For example, computer system S₁ can execute steps 306-314 of flowchart 300 on the batch sent by computer system S₂.

At step 518, computer system S₂ can receive an acknowledgement message from computer system S₁ indicating that current training iteration i has been completed and whether another training iteration is needed. In certain embodiments, the acknowledgement message can also include information regarding the current state of DNN M (e.g., most recent loss value, etc.), which computer system S₂ can use to dynamically determine the compression level to be applied in the next iteration.

If the acknowledgement message indicates that another training iteration is needed (step 520), computer system S₂ can increment the iteration variable i (step 522) and return to step 506. However, if the acknowledgement message indicates that another training iteration is not needed, flowchart 500 can end.

### 4. Instance-Level Compression

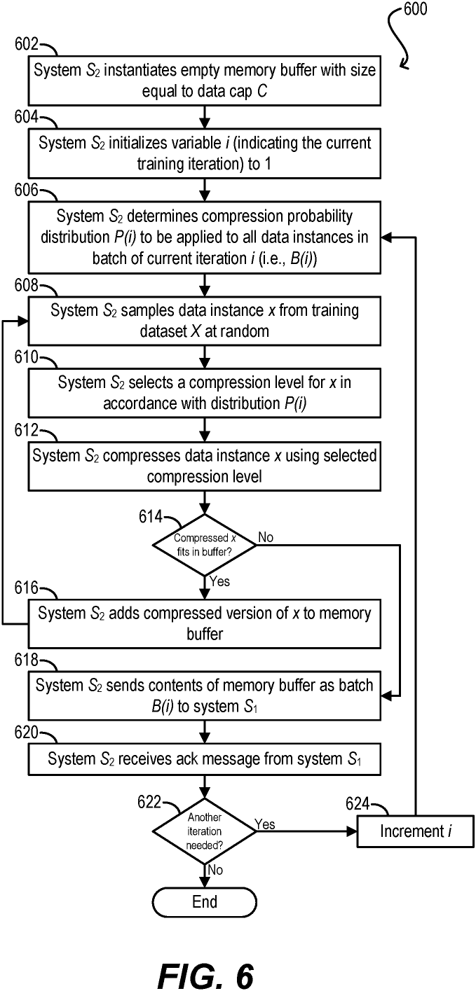

FIG. 6 depicts a flowchart 600 of the steps that may be performed by computer systems S₁ and S₂ of FIG. 1 for implementing the instance-level compression scheme as part of training DNN M on training dataset X according to certain embodiments. Like flowchart 500 of FIG. 5, flowchart 600 assumes that these computer systems are subject one or more network bandwidth constraints that place a data cap C on the total amount of data that may be communicated from computer system S₂ to computer system S₁ during each iteration of the training procedure. In addition, flowchart 600 assumes that computer system S₂ has defined a set of compression levels E that may be applied to the data instances in training dataset X (e.g., low, medium, high).

Starting with steps 602 and 604, computer system S₂ can instantiate an empty memory buffer having a size equal to data cap C and can initialize a variable i indicating the current training iteration to 1.

At step 606, computer system S₂ can determine a compression probability distribution P(i) for all data instances in the batch of current iteration i (i.e., batch B(i)). This compression probability distribution can include, for each compression level in the set of compression levels E, a probability value between 0 and 1 which indicates the likelihood that the compression level will be chosen for compressing each data instance in batch B(i). In various embodiments, computer system S₂ can determine compression probability distribution P(i) deterministically (e.g., based on a predefined schedule) or dynamically (e.g., based on a current state of DNN M). In a particular embodiment, compression probability distribution P(i) can be skewed to favor (i.e., include higher probabilities for) higher compression levels in earlier iterations of the training procedure and favor lower compression levels in later iterations of the training procedure.

It should be noted that in the case where compression probability distribution P(i) always defines a probability of 1 for a single compression level in E and a probability value of 0 for all other compression levels in E, this scheme is functionally identical to the batch-level compression scheme (which applies the same compression level to all data instances in a given batch/iteration).

At step 608, computer system S₂ can sample a data instance x from training dataset X at random. Computer system S₂ can then select, from the set of compression levels E, a compression level for data instance x in accordance with compression probability distribution P(i) (step 610), compress x using the selected compression level (step 612), and check whether the compressed version of x fits into the memory buffer (step 614).

If the answer at step 614 is yes, computer system S₂ can add the compressed version of data instance x to the memory buffer and return to step 608 in order to sample a next data instance (step 616). However, if the answer at step 614 is no, computer system S₂ can conclude that the memory buffer is now full (or in other words, the total data size of batch B(i) for current training iteration i has reached data cap C) and can send the contents of the memory buffer as the batch for iteration i to computer system S₁, thereby enabling S₁ to train DNN M on this batch (step 618).

At step 620, computer system S₂ can receive an acknowledgement message from computer system S₁ indicating that current training iteration i has been completed and whether another training iteration is needed. In certain embodiments, the acknowledgement message can also include information regarding the current state of DNN M (e.g., most recent loss value, etc.), which computer system S₂ can use to dynamically determine the compression probability distribution to be used for the next iteration.

If the acknowledgement message indicates that another training iteration is needed (step 622), computer system S₂ can increment the iteration variable i (step 624) and return to step 606. However, if the acknowledgement message indicates that another training iteration is not needed, flowchart 600 can end.

### 5. Importance Sampling-Based Compression

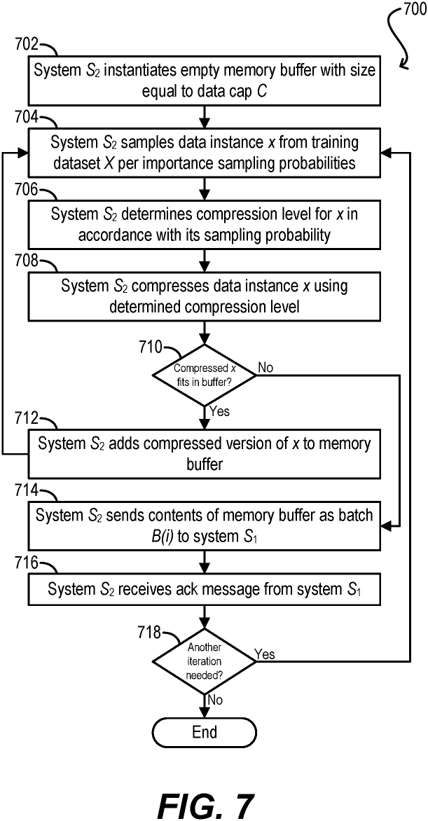

FIG. 7 depicts a flowchart 700 of the steps that may be performed by computer systems S₁ and S₂ of FIG. 1 for implementing the importance sampling-based compression scheme as part of training DNN M on training dataset X according to certain embodiments. Like flowcharts 400 and 500 of FIGS. 4 and 5, flowchart 700 assumes that these computer systems are subject one or more network bandwidth constraints that place a data cap C on the total amount of data that may be communicated from computer system S₂ to computer system S₁ during each iteration of the training procedure. In addition, flowchart 700 assumes that computer system S₂ (or some other entity) has implemented a mechanism for periodically updating sampling probabilities for the data instances in training dataset X in order to support importance sampling.

Starting with step 702, computer system S₂ can instantiate an empty memory buffer having a size equal to data cap C.

At step 704, computer system S₂ can sample a data instance x from training dataset X in accordance with the current sampling probabilities assigned to the data instances in X. Computer system S₂ can then determine a compression level for data instance x based on x’s sampling probability (step 706), compress x using the determined compression level (step 708), and check whether the compressed version of x fits into the memory buffer (step 710).

If the answer at step 710 is yes, computer system S₂ can add the compressed version of data instance x to the memory buffer and return to step 704 in order to sample a next data instance (step 712). However, if the answer at step 710 is no, computer system S₂ can conclude that the memory buffer is now full (or in other words, the total data size of the batch for current training iteration i has reached data cap C) and can send the contents of the memory buffer as the batch for iteration i to computer system S₁, thereby enabling S₁ to train DNN M on this batch (step 714).

At step 716, computer system S₂ can receive an acknowledgement message from computer system S₁ indicating that current training iteration has been completed and whether another training iteration is needed. If the acknowledgement message indicates that another training iteration is needed (step 718), computer system S₂ can return to step 704. However, if the acknowledgement message indicates that another training iteration is not needed, flowchart 700 can end.

### 6. Extensions/Modifications

Although flowcharts 500, 600, and 700 assume that computer system S₂ is configured to accumulate compressed data instances for each batch/iteration in a memory buffer of size C and then send the contents of the memory buffer to computer system S₁ once the buffer is full, in alternative embodiments S₂ may send each compressed data instance to S₁ individually, immediately after it has been compressed. In these embodiments, computer system S₂ can keep a running tally of the amount of data that has been transmitted to computer system S₁ in each iteration and “close out” the batch (or in other words, stop sending additional data instances for that batch/iteration) once the tally reaches data cap C.

Further, if computer system S₂ is aware of the best-practice batch size for DNN M, in certain embodiments computer system S₂ can modify its logic to ensure that the size of each batch transmitted to computer system S₁ never exceeds this best-practice size (regardless of whether a larger batch can fit within data cap C).

Yet further, some lossy compression algorithms offer the choice of providing fixed noise or dynamic noise. With fixed noise, the compression algorithm will always generate the same noise in a given data instance each time the algorithm compresses that data instance. With dynamic noise, the compression algorithm will generate different noise in a given data instance each time the algorithm compresses that data instance (by, e.g., using a different seed value). For such algorithms, computer system S₂ can choose to compress data instances using the fixed noise option or the dynamic noise option. The former will generally lead to faster convergence of DNN M, whereas the latter may improve the generalization properties and/or robustness of M because each time a data instance is compressed, its content will be slightly different (and thus will appear to the training procedure as a new/different data instance).

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
sampling, by a first computer system, a batch of data instances from a training dataset local to the first computer system;
compressing, by the first computer system, one or more data instances in the batch using a lossy compression algorithm, the compressing resulting in a compressed batch; and
transmitting, by the first computer system, the compressed batch to a second computer system holding a machine learning (ML) model,
wherein the second computer system is configured to execute an iteration of a training procedure on the ML model using the compressed batch,
wherein one or more network bandwidth constraints place a data cap on an amount of data that may be transmitted from the first computer system to the second computer system for each iteration of the training procedure, and
wherein the compressing results in a data size for the compressed batch that is less than or equal to the data cap.

2. The method of claim 1 wherein the compressing comprises:
determining a compression level to be applied to all data instances in the batch; and
compressing each of the one or more data instances using the compression level.

3. The method of claim 2 wherein the compression level is determined statically using a predefined schedule that assigns different compression levels to different iterations of the training procedure.

4. The method of claim 2 wherein the compression level is determined dynamically based on a current training state of the ML model.

5. The method of claim 1 wherein the compressing comprises, for each of the one or more data instances:
selecting, via a compression probability distribution, a compression level to be applied to the data instance; and
compressing the data instance using the compression level.

6. The method of claim 5 wherein the compression probability distribution is determined statically using a predefined schedule that assigns different compression probability distributions to different iterations of the training procedure.

7. The method of claim 5 wherein the compression probability distribution is determined dynamically based on a current training state of the ML model.

8. The method of claim 1 wherein the batch is sampled in accordance with importance sampling probabilities assigned to data instances in the training dataset, and
wherein the compressing comprises, for each of the one or more data instances:
selecting a compression level to be applied to the data instance based on the data instance’s importance sampling probability; and
compressing the data instance using the compression level.

9. A non-transitory computer readable storage medium having stored thereon program code executable by a first computer system holding a training dataset, the program code causing the first computer system to execute a method comprising:
sampling a batch of data instances from the training dataset;
compressing one or more data instances in the batch using a lossy compression algorithm, the compressing resulting in a compressed batch; and
transmitting the compressed batch to a second computer system holding a machine learning (ML) model,
wherein the second computer system is configured to execute an iteration of a training procedure on the ML model using the compressed batch,
wherein one or more network bandwidth constraints place a data cap on an amount of data that may be transmitted from the first computer system to the second computer system for each iteration of the training procedure, and
wherein the compressing results in a data size for the compressed batch that is less than or equal to the data cap.

10. The non-transitory computer readable storage medium of claim 9 wherein the compressing comprises:
determining a compression level to be applied to all data instances in the batch; and
compressing each of the one or more data instances using the compression level.

11. The non-transitory computer readable storage medium of claim 10 wherein the compression level is determined statically using a predefined schedule that assigns different compression levels to different iterations of the training procedure.

12. The non-transitory computer readable storage medium of claim 10 wherein the compression level is determined dynamically based on a current training state of the ML model.

13. The non-transitory computer readable storage medium of claim 9 wherein the compressing comprises, for each of the one or more data instances:
selecting, via a compression probability distribution, a compression level to be applied to the data instance; and
compressing the data instance using the compression level.

14. The non-transitory computer readable storage medium of claim 13 wherein the compression probability distribution is determined statically using a predefined schedule that assigns different compression probability distributions to different iterations of the training procedure.

15. The non-transitory computer readable storage medium of claim 13 wherein the compression probability distribution is determined dynamically based on a current training state of the ML model.

16. The non-transitory computer readable storage medium of claim 9 wherein the batch is sampled in accordance with importance sampling probabilities assigned to data instances in the training dataset, and
wherein the compressing comprises, for each of the one or more data instances:
selecting a compression level to be applied to the data instance based on the data instance’s importance sampling probability; and
compressing the data instance using the compression level.

17. A computer system comprising:
a processor;
a storage component holding a training dataset; and
a non-transitory computer readable medium having stored thereon program code that, when executed by the processor, causes the processor to:
sample a batch of data instances from the training dataset;
compress one or more data instances in the batch using a lossy compression algorithm, the compressing resulting in a compressed batch; and
transmit the compressed batch to another computer system holding a machine learning (ML) model,
wherein said another computer system is configured to execute an iteration of a training procedure on the ML model using the compressed batch,
wherein one or more network bandwidth constraints place a data cap on an amount of data that may be transmitted from the computer system to said another computer system for each iteration of the training procedure, and
wherein the compressing results in a data size for the compressed batch that is less than or equal to the data cap.

18. The computer system of claim 17 wherein the program code that causes the processor to compress the batch comprises program code that causes the processor to:
determine a compression level to be applied to all data instances in the batch; and
compress each of the one or more data instances using the compression level.

19. The computer system of claim 18 wherein the compression level is determined statically using a predefined schedule that assigns different compression levels to different iterations of the training procedure.

20. The computer system of claim 18 wherein the compression level is determined dynamically based on a current training state of the ML model.

21. The computer system of claim 17 wherein the program code that causes the processor to compress the batch comprises program code that causes the processor to, for each of the one or more data instances:
select, via a compression probability distribution, a compression level to be applied to the data instance; and
compress the data instance using the compression level.

22. The computer system of claim 21 wherein the compression probability distribution is determined statically using a predefined schedule that assigns different compression probability distributions to different iterations of the training procedure.

23. The computer system of claim 21 wherein the compression probability distribution is determined dynamically based on a current training state of the ML model.

24. The computer system of claim 17 wherein the batch is sampled in accordance with importance sampling probabilities assigned to data instances in the training dataset, and
wherein the program code that causes the processor to compress the batch comprises program code that causes the processor to, for each of the one or more data instances:
select a compression level to be applied to the data instance based on the data instance’s importance sampling probability; and
compress the data instance using the compression level.
